(19) United States
(12) Patent Application Publication
(10) Pub. No.: US 2015/0298424 A1
(43) Pub. Date: Oct. 22, 2015

(54) LAYER COMPOSITE, METHOD FOR THE PRODUCTION THEREOF AS WELL AS USES THEREOF

(71) Applicant: SCHOTT AG, Mainz (DE)

(72) Inventors: Yvonne Menke, Wiesbaden (DE); Volker Hagemann, Klein-Winternheim (DE); Andreas Roosen, Erlangen (DE); Michael Beck, Nuernberg (DE)

(21) Appl. No.: 14/688,629

(22) Filed: Apr. 16, 2015

(30) Foreign Application Priority Data
Apr. 16, 2014 (DE) 10 2014 105 470.9

(51) Int. Cl. B32B 3/26; B32B 18/00

(52) U.S. Cl. CPC B32B 3/26; B32B 18/00; B32B 2305/026; B32B 2307/414; B32B 2457/00; C04B 2237/343

(57) ABSTRACT

A layer composite is provided that includes optoceramic layers. Additionally, a method for the production of the layer composite, as well as uses thereof are also provided. The layer composite is suitable as a converter material such as a converter material for LEDs. With the use of the layer composite, white LEDs can be produced which also in the passive state, i.e. when the light source is switched off, result in a white color impression.

### CROSS REFERENCE TO RELATED APPLICATIONS

This application claims benefit under 35 U.S.C. §119(a) of German Patent Application No. 10 2014 105 470.9 filed Apr. 16, 2014, the entire contents of which are incorporated herein by reference.

### BACKGROUND

1. Field of the Disclosure

The present invention relates to a layer composite comprising optoceramic layers, a method for the production thereof as well as uses thereof. The layer composite according to the present invention is particularly suitable as a converter material, in particular as a converter material for LEDs (light-emitting diodes) and LDs (laser diodes).

2. Description of the Related Art

Currently, known converter materials are predominantly used in LED-based illuminants. LED converter materials are active media which absorb the radiation of the LED light source with relatively low wave length (primary radiation) directly or via a plurality of intermediate steps partially, wherein electron-hole pairs are created. Their recombination results in excitation of an activator center which is nearby. During this process the last one is raised into an excited metastable state. Its relaxation depending on the choice of the activator results in emission of light with long wave length (secondary radiation). Since the emitted light has lower energy than the excitation light, this conversion is also referred to as “down conversion”. In addition a part of the non-absorbed primary radiation passes the converter, wherein primary and secondary radiations again result in a color location which is different from that of the primary radiation.

For illumination purposes mostly a blue LED is combined with a yellow luminescent material which in most cases is cerium-doped yttrium aluminum garnet (Ce:YAG). In the case of these so-called “white LEDs” white light is created by mixture of partially transmitted blue LED light and yellow fluorescence radiation. The color location of the emitted light depends on the amount of absorbed blue LED light which is emitted as yellow light and the amount of blue light which passes the converter without any absorption.

Normally, Ce:YAG particles are embedded in the silicone layer in which the LED is encapsulated. As an alternative to this technology from prior art approaches are known in which Ce:YAG is used as a ceramic substrate. US 2006/0124951 A1, US 2006/0250069 A1 and EP 1 980 606 A1 disclose ceramic converters consisting of at least two phases, e.g. Al₂O₃ and Ce:YAG, which are free of pores. The production involves arbitrary crystallization from a YAG melt being enriched with Al₂O₃. But the melting process is not suitable for the targeted and reproducible adjustment of a grain structure. Thus also the color location of the light being emitted from the converter cannot be adjusted in a targeted manner.

WO 2011/094404 A1 discloses a porous ceramic converter. For generating pores organic additives are used which are burned out during sintering. The use of organic additives is costly. Furthermore, when the burning out process is incomplete, then carbonaceous residues of the additives remain in the converter and result in reduced quantum efficiency of the converter.

From WO 2009/038674 A2 ceramic layer composites with a dopant gradient over a part of the thickness of the layer composite are known. The manufacture of such a dopant gradient requires the separate production of different slips with different fractions of dopants. Such a production method results in a complicated, laborious and costly manufacturing process with separated weighing in and processing steps of the individual slips.

WO 2011/115820 A1 discloses an LED converter which may comprise two or three ceramic emission layers which are doped with the same dopant. In addition, the converter may also comprise non-emitting ceramic layers which are arranged between the emission layers. Porous ceramic layers are not disclosed.

WO 2012/040046 A1 discloses an LED converter containing at least one ceramic emission layer and at least one non-emitting layer which preferably consists of Al₂O₃ as blocking material. The blocking material reduces the diffusion of dopants into the non-emitting layer. Porous ceramic layers are not disclosed.

The white LEDs which are known from prior art in the passive state, i.e. when the light source is switched off, due to the converter materials used appear to be yellow. This yellow color impression is troublesome for human beings and therefore a need for white LEDs which appear to be white also in the passive state exists.

### SUMMARY

Therefore, it is an object of the present invention to provide a layer composite which is suitable as a converter for LEDs and with which white LEDs and LDs can be produced which also in the passive state are characterized by a white color impression.

The object is in particularly solved by a layer composite comprising at least one porous optoceramic layer and at least one further optoceramic layer, wherein the porous optoceramic layer comprises pores in a volume fraction of at least 2.5%.

Preferably, the at least one porous optoceramic layer due to the pores results in a white color impression. Preferably, the at least one porous optoceramic layer defines the color impression of the layer composite according to the present invention, at least in the case of a view from one side.

Preferably, the volume fraction of the pores is determined optically by means of scanning electron microscopy.

Preferably, the pores have a maximum inner diameter of at least 0.1 μm, more preferably at least 0.5 μm, still more preferably at least 1 μm. When the pores are too small, then the scattering effects are not high enough. Preferably, the pores have a maximum inner diameter of at most 50 μm, more preferably at most 20 μm, still more preferably at most 10 μm, particularly preferably at most 5 μm. When the pores are too large, then the scattering of the light is too strong. Preferably, the pore size is determined by means of scanning electron microscopy. The determination of the pore size with the help of scanning electron microscopy pictures is preferably conducted by means of an image analysis software. The scanning electron microscopy pictures are preferably recorded from micrographs.

The further optoceramic layer preferably comprises pores in a volume fraction of at most 1.5%, more preferably at most 1.1%, more preferably at most 1%, still more preferably at most 0.5%, particularly preferably at most 0.05%.

The porous optoceramic layer more preferably comprises pores in a volume fraction of at least 3%, still more preferably at least 3.5%. When the fraction of pores is too low, then the scattering effects are not high enough. Preferably, the porous optoceramic layer comprises pores in a volume fraction of at most 20%, more preferably at most 10%, especially preferably at most 5%. When the fraction of the pores is too high, then mechanically instable optoceramic layers are obtained.

Preferably, the fraction of the pores can be adjusted in a targeted manner. Particularly preferably, the fraction of the pores is adjusted by the ratio of binder and softener components to ceramic components which are used for the production of the optoceramic layers as described in detail below. In an alternative or in addition also organic additives, preferably dextrose, can be used for the formation of the pores.

Preferably, the layer composite does not comprise more than eight optoceramic layers, more preferably exactly five optoceramic layers, still more preferably exactly four optoceramic layers, especially preferably exactly three optoceramic layers. In an alternative the layer composite may also comprise exactly two optoceramic layers.

Preferably, the optoceramic layers are polycrystalline.

Preferably, the optoceramic layers comprise an optoceramic phase. Preferably, the optoceramic phase comprises crystallites. Particularly preferably, the optoceramic phase consists of crystallites of the same composition.

Particularly preferably, the crystallites are selected from garnets, cubic sesquioxides, spinels, perovskites, pyrochlores, fluorites, oxynitrides and mixed crystals of two or more thereof. Especially preferably, the crystallites are selected from garnets, spinels, oxynitrides and mixed crystals of two or more thereof. Still more preferably, the crystallites are selected from garnets, oxynitrides and mixed crystals thereof.

The garnets are preferably selected from yttrium aluminum garnets (YAG), yttrium gadolinium aluminum garnets (YGAG), gadolinium gallium garnets (GGG), lutetium aluminum garnets (LuAG), lutetium aluminum gallium garnets (LuAGG), yttrium scandium aluminium garnets (YSAG) and mixed crystals thereof.

The cubic sesquioxides are preferably selected from Y₂O₃, Gd₂O₃, Sc₂O₃, Lu₂O₃, Yb₂O₃ and mixed crystals thereof.

The oxynitrides are preferably selected from AlON, BaSiON, SrSiON and mixed crystals thereof as well as from alpha and beta Sialon. AlON has a cubic crystal structure, while BaSiON and SrSiON have a non-cubic crystal structure.

The spinels are preferably selected from ZnAl₂O₄, SrAl₂O₄, CaAl₂O₄, MgAl₂O₄ and mixed crystals thereof. In alternative embodiments the spinels are preferably selected from ZnGa₂O₄, SrGa₂O₄, CaGa₂O₄, MgGa₂O₄ and mixed crystals thereof.

In preferable embodiments the crystallites have cubic crystal structure. The cubic phase has an identical refractive index in all three spatial directions. So birefringence of the light within the single crystallites and thus loss by scattered light can be prevented. Furthermore, the cubic crystal structure is particularly suitable for doping with optically active centers.

In alternative embodiments the crystallites have non-cubic crystal structure. In these embodiments the crystallites are preferably selected from non-cubic sesquioxides, non-cubic oxynitrides and mixed crystals thereof. Particularly preferably the crystallites are non-cubic sesquioxides.

Preferably, the non-cubic sesquioxides are selected from Gd₂O₃, La₂O₃, Al₂O₃, Lu₂Si₂O₇ and mixed crystals thereof.

Preferably, the crystallites are oxidic. Oxidic crystallites can be prepared in a particularly easy manner. Oxidic crystallites can more easily be processed due to the fact that they impose lower requirements on the industrial manufacturing equipment used (gas atmosphere, gas pressure during sintering).

In a preferable embodiment the crystallites have the chemical empirical formula AₓB_{y}O_{z} with x≧1, y≧0 and x+y=⅔z. A is preferably a member of the scandium group or belongs to the lanthanides. A is particularly preferably selected from yttrium, scandium, gadolinium, ytterbium, lutetium or several elements thereof. B is preferably a member of the boron group. B is particularly preferably selected from aluminum, gallium or several elements thereof. Especially preferably the crystallites have the chemical empirical formula Y₃Al₅O₁₂.

In a further preferable embodiment the crystallites have the chemical empirical formula AₓB_{y}C_{w}O_{z} with x, y, w≧1 and x+y+w=⅔z. A is preferably a member of the scandium group or belongs to the lanthanides. A is particularly preferably selected from yttrium, lutetium or several elements thereof. B is preferably a member of the boron group. B is particularly preferably selected from aluminum, gallium or several elements thereof. C is preferably a member of the boron group or belongs to the lanthanides. C is particularly preferably selected from gallium, gadolinium, lanthanum, lutetium or several elements thereof.

In a further preferable embodiment the crystallites have the chemical empirical formula AₓB_{y}O_{z} with x, y≧1, y=2x and x+y=¾z. In this embodiment A is preferably a member of the group of alkaline-earth metals or of the zinc group. A is particularly preferably magnesium, calcium, strontium or zinc. Especially preferably, A is magnesium or zinc. Preferably, B is a member of the boron group. Particularly preferably B is aluminum.

In a preferable embodiment the optoceramic phase of at least one of the optoceramic layers comprises at least one optically active center. Particularly preferably, the optoceramic phase of the at least one further optoceramic layer comprises at least one optically active center. Preferably, the optically active center is selected from rear-earth element ions and transition metal ions. Particularly preferably, the optically active center is selected from ions of one or more of the elements Ce, Cr, Eu, Nd, Mn, Tb, Er, Co, Pr and Sm. Especially preferably, the optically active center is selected from ions of one or more of the elements Ce, Cr, Eu, Tb, Pr and Sm. Still more preferably, the optically active center is selected from ions of one or more of the elements Ce, Pr and Eu. Still more preferably, the optically active center is selected from ions of one or more of the elements Ce and Eu. Still more preferably, the optically active center is an ion of the element Ce. The optically active center preferably conduces to the conversion of incident radiation of one wave length into radiation of another wave length.

Preferably, the optoceramic phase comprises the optically active center in a fraction of at least 0.01% by weight, more preferably at least 0.03% by weight, particularly preferably at least 0.045% by weight. When the fraction of the optically active center is too low, then the light which is converted is not sufficient. Preferably, the optoceramic phase comprises the optically active center in a fraction of at most 1% by weight, more preferably at most 0.7% by weight, particularly preferably at most 0.55% by weight. When these values are fulfilled, then this results in an excellent conversion.

Preferably, the optoceramic phase comprises the optically active center in a fraction of at least 0.002 atom-%, more preferably at least 0.004 atom-%, particularly preferably at least 0.008 atom-%. When the fraction of the optically active center is too low, then the light which is converted is not sufficient. Preferably, the optoceramic phase comprises the optically active center in a fraction of at most 0.2 atom-%, more preferably at most 0.15 atom-%, particularly preferably at most 0.1 atom-%. When these values are fulfilled, then this results in an excellent conversion.

According to the present invention optoceramic layers the optoceramic phase of which comprises optically active center in a fraction of at least 0.01% by weight are referred to as “doped optoceramic layers”. According to the present invention the at least one porous and/or the at least one further optoceramic layer of the layer composite according to the present invention may be doped optoceramic layers. Particularly preferably, the at least one further optoceramic layer is a doped optoceramic layer.

In a particularly preferable embodiment the optoceramic phase of at least one of the optoceramic layers, preferably the optoceramic phase of the at least one porous optoceramic layer, comprises the optically active center in a weight fraction of at most 10 ppm, more preferably at most 5 ppm, still more preferably at most 1 ppm. Especially preferably, the optoceramic phase of at least one of the optoceramic layers, preferably the optoceramic phase of the at least one porous optoceramic layer, is free of optically active center. In this manner the white color impression in the passive state can further be enhanced.

According to the present invention optoceramic layers the optoceramic phase of which comprises optically active center in a weight fraction of at most 10 ppm are referred to as “undoped optoceramic layers”. According to the present invention the at least one porous and/or the at least one further optoceramic layer of the layer composite according to the present invention may be undoped optoceramic layers. In preferable embodiments the at least one porous optoceramic layer is an undoped optoceramic layer. In alternative embodiments the at least one further layer is an undoped optoceramic layer.

Preferably, the layer composite according to the present invention comprises at least one doped optoceramic layer. Preferably, the layer composite according to the present invention comprises at least one undoped optoceramic layer. Particularly preferably, the layer composite according to the present invention comprises both at least one doped and at least one undoped optoceramic layer.

Preferably, the at least one undoped optoceramic layer has a layer thickness of at least 5 μm, more preferably at least 10 μm, still more preferably at least 20 μm, particularly preferably at least 40 μm. When the undoped optoceramic layer is too thin, then the stability of the layer is not sufficient. Preferably, the at least one undoped optoceramic layer has a layer thickness of at most 120 μm, more preferably at most 100 μm, still more preferably at most 80 μm, particularly preferably at most 60 μm. When the thickness of the undoped optoceramic layer is too high, then the reduction of the internal transmittance is too strong. In addition, in the case of higher layer thicknesses internal total reflection may take place in a higher extent.

Preferably, the at least one doped optoceramic layer has a layer thickness of at least 50 μm, more preferably at least 80 μm, still more preferably at least 100 μm, particularly preferably at least 150 μm, especially preferably at least 200 μm. When the thickness of the doped optoceramic layer is too low, then the stability of the layer is not sufficient. Preferably, the at least one doped optoceramic layer has a layer thickness of at most 1000 μm, more preferably at most 750 μm, still more preferably at most 500 μm, particularly preferably at most 300 μm. When the thickness of the doped optoceramic layer is too high, then the reduction of the internal transmittance is too strong. Furthermore, with a suitable layer thickness the internal total reflection of the converted light can be reduced.

Preferably, the layer thickness of the at least one doped optoceramic layer is higher than the layer thickness of the at least one undoped optoceramic layer. Particularly preferably, the layer thickness of the at least one doped optoceramic layer is at least two times as high, more preferably at least three times as high, still more preferably at least four times as high, especially preferably at least five times as high as the layer thickness of the at least one undoped optoceramic layer. In this manner layer composites with excellent conversion properties are obtained.

Preferably, the layers of the layer composite according to the present invention are translucent. Preferably, the layer composite is translucent.

Preferably, the optoceramic phase is translucent. More preferably, the optoceramic phase is transparent.

The optoceramic phase is transparent in the sense of the present invention, when, in the case of a thickness of 2 mm, it has an internal transmittance of electromagnetic radiation in a range with a width of 50 nm within a spectrum of 380 to 800 nm of higher than 25%, preferably higher than 60%, more preferably higher than 80%, still more preferably higher than 90%, particularly preferably higher than 95%.

In a preferable embodiment the layer composite comprises at least two porous optoceramic layers as described above as well as at least one further optoceramic layer.

In a preferable embodiment the layer composite consists of exactly two porous optoceramic layers as well as one further optoceramic layer which is disposed between both porous optoceramic layers. Such a layer composite can be produced in a particularly easy and efficient manner as described below. In this embodiment the further optoceramic layer is preferably a doped optoceramic layer and both porous optoceramic layers are preferably undoped optoceramic layers.

In a more preferable embodiment the layer composite according to the present invention consists of exactly one porous optoceramic layer and exactly one further optoceramic layer. In this embodiment the further optoceramic layer is preferably a doped optoceramic layer and the porous optoceramic layer is preferably an undoped optoceramic layer.

A layer composite according to the present invention may optionally be connected with an at least partially reflecting layer. In such embodiments preferably one undoped optoceramic layer in the layer composite is disposed between one doped optoceramic layer and the at least partially reflecting layer. Preferably, the doped optoceramic layer is a porous optoceramic layer. Preferably, the undoped optoceramic layer is a further optoceramic layer in the sense of the present invention. The at least partially reflecting layer is preferably present in the layer composite in the form of a mirror. In an alternative also a metallic coating may serve as a partially reflecting layer. With the at least partially reflecting layer the emission of yellow light from the layer composite can be increased.

In the case of the LED converters known from prior art a majority of the blue light is absorbed within a relative short way after entry into the converter material. In the remaining way through the converter material the absorption is considerably lower, since already a majority of the blue light has been absorbed. Normally, the absorption involves generation of heat. Thus, in the case of the converters known from prior art due to the uneven absorption an uneven generation of heat in the converter material results which in the long run has a negative influence onto the material properties. Therefore a need for converter materials which guarantee a more even generation of heat exists.

According to a particularly preferable embodiment of the present invention such converter materials can be obtained. In such a particularly preferable embodiment the layer composite according to the present invention comprises at least three doped porous optoceramic layers, wherein the optoceramic phases of which have different contents of optically active center, based on the weight. Preferably, in this embodiment the content of active center in the doped optoceramic layer with the highest content of active center is at least two times as high, more preferably at least three times as high, still more preferably at least four times as high as the content of active center in the doped optoceramic layer with the lowest content of optically active center. It is particularly preferable that the doped optoceramic layers in the layer composite are arranged in the form of a gradient so that the light to be converted successively passes doped optoceramic layers with increasing content of optically active center. In this manner an even generation of heat can be achieved.

The object according to the present invention is further solved by a method for the production of layer composites according to the present invention. This method preferably comprises the following steps: providing of a slip of starting materials, producing of green foils from the slip, providing of a layer arrangement of the green foils, comprising at least one porous and at least one further layer, bonding of the layers of the layer arrangement to a layer composite, and sintering of the layer composite.

Preferable starting materials for providing the slip according to step a) of the method according to the present invention comprise ceramic powder, sintering aids, solvents, dispersing agents, binders and softeners. More preferably, the starting materials for providing the slip consist of ceramic powder, sintering aids, solvents, dispersing agents, binders and softeners.

Preferably, nanoscale ceramic powders with primary particles having diameters of smaller than 1 μm are used.

Preferable ceramic powders are selected from Al₂O₃ powder, Y₂O₃ powder, Gd₂O₃ powder, Ga₂O₃ powder, Lu₂O₃ powder, CeO₂ powder and mixtures thereof. It is particularly preferable, when the ceramic powder is a mixture of several of the mentioned oxides. With a suitable mixture the color location can already be roughly adjusted (yellow, warm white, orange, green, etc.). Preferable mixtures comprise: Al₂O₃, Y₂O₃ and CeO₂ powders, Al₂O₃, Y₂O₃, Gd₂O₃ and CeO₂ powders, Al₂O₃, Lu₂O₃ and CeO₂ powders, and Al₂O₃, Ga₂O₃, Lu₂O₃ and CeO₂ powders.

Preferably, the ceramic powders have a specific surface of at least 2 m²/g, more preferably at least 5 m²/g, still more preferably at least 12 m²/g. When the specific surface is too small, then the sintering activity of the ceramic powder is too low. As a result the densification during sintering is not sufficient. Preferably, the ceramic powders have a specific surface of at most 100 m²/g, more preferably at most 50 m²/g, still more preferably at most 30 m²/g. When the specific surface is too large, then the processability of the ceramic powders is too poor. The reasons for the processability which is too poor are the formation of strong agglomerates due to the high surface energy of the small particles as well as the limitation, when higher filling degrees are desired to be adjusted (strong increase of the viscosity due to higher interactions between the particles).

Preferably, the ceramic powders have a chemical purity of at least 99% by weight, more preferably at least 99.9% by weight, still more preferably at least 99.99% by weight, particularly preferably at least 99.999% by weight.

For the formation of the optically active center preferably oxides of rear-earth element ions and transition metal ions are used, particularly preferably CeO₂ and/or Eu₂O₃, especially preferably CeO₂.

Preferably, CeO₂ is used in a fraction of at least 0.05% by weight, more preferably at least 0.1% by weight, still more preferably at least 0.15% by weight, particularly preferably at least 0.2% by weight, based on the total weight of the ceramic powders used. When the fraction is too low, then the light which is converted is not sufficient. Preferably, CeO₂ is used in a fraction of at most 3% by weight, more preferably at most 2% by weight, still more preferably at most 1% by weight, especially preferably at most 0.8% by weight, based on the total weight of the ceramic powders used. When these values are fulfilled, then this results in an excellent conversion.

In alternative embodiments Eu₂O₃ is used for the formation of the optically active center. Preferably, Eu₂O₃ is used in a fraction of at least 0.1% by weight, more preferably at least 0.2% by weight, still more preferably at least 0.5% by weight, particularly preferably at least 1% by weight, based on the total weight of the ceramic powders used. When the fraction is too low, then the converted light is not enough. Preferably, Eu₂O₃ is used in a fraction of at most 6% by weight, more preferably at most 5% by weight, still more preferably at most 4% by weight, especially preferably at most 3.5% by weight, based on the total weight of the ceramic powders used. When these values are fulfilled, then this results in an excellent conversion.

Preferable solvents are selected from methanol, methyl ethyl ketone (MEK), isopropanol, butanol, acetone, ethylene glycol, terpineols, trichloroethylene, water, ethanol, toluene and mixtures thereof. It is particularly preferable, when the solvents are selected from ethanol, toluene and mixtures thereof. Preferably, the solvents have a chemical purity of at least 90% by weight, more preferably at least 95% by weight, still more preferably at least 99% by weight, particularly preferably at least 99.9% by weight.

A preferable sintering aid is tetraethyl orthosilicate (TEOS). In an alternative, when garnets are used, also SiO₂ can be used as a sintering aid. But TEOS is more practicable in the processing step of the slip, because it is liquid and thus it is not necessary to homogenously distribute it via dispersion. TEOS reacts with atmospheric moisture or at increased temperatures in air to SiO₂, which thus is present in a homogenous distribution.

In the case of pyrochlores, in addition, as sintering aids preferably HfO₂, ZrO₂, TiO₂ and/or rear-earth element fluorides can be used.

In the case of oxynitrides, in addition, the sintering aids are preferably selected from MgO, CaO, rear-earths and mixtures thereof.

Preferably, the sintering aids have a chemical purity of at least 90% by weight, more preferably at least 95% by weight, still more preferably at least 99% by weight, particularly preferably at least 99.9% by weight.

The dispersing agent is preferably selected from trioxadecanoic acid (TODS), polyacrylic acid (PAA) and mixtures thereof. Particularly preferable is the dispersing agent TODS. In an alternative also D1001, D1005 and/or D1004 can be used as a dispersing agent. In further alternative embodiments the dispersing agent is preferably selected from the group consisting of fish oil, oleic acid, short-chain co-blockpolymers with a molecular weight of lower than 5000 g/mol, short-chain organic acids as well as mixtures thereof. Preferably, the dispersing agent has a chemical purity of at least 90% by weight, more preferably at least 95% by weight, still more preferably at least 99% by weight, particularly preferably at least 99.9% by weight.

Besides the steric stabilization and/or electrosteric stabilization, in the case of the use of water also electrostatic stabilization is possible, wherein no organic additives are necessary, but the surface charges of the powders are utilized. This charge can be influenced by the adjustment of suitable pH values or by the addition of ions.

As a binder preferably polymer binders which can be dissolved in the solvent according to the present invention are used. Preferably, during drying of the slip the binder forms a film and, after drying of the slip, it can easily be removed from the carrier foil and/or the cast strip. Preferably, the binder is characterized by sufficient flexibility and lamination capability. The binder is preferably selected from polyvinyl butyral (PVB), polyethylene glycol (PEG), polyvinylpyrrolidone (PVP), acrylates, polyvinyl alcohol (PVA), dispersion binders and mixtures thereof. Preferable polyethylene glycols are PEG 400 and PEG 4000. It is particularly preferable, when the binder is PVB. It is particularly preferable to use PVB with an average molecular weight of 20000 to 100000 g/mol, still more preferably 50000 to 80000 g/mol. In an alternative also V05606 (Zschimmer & Schwarz) can be used as a binder. Preferably, the binder has a chemical purity of at least 90% by weight, more preferably at least 95% by weight, still more preferably at least 99% by weight, particularly preferably at least 99.9% by weight.

Softeners are preferably used for reducing the glass transition temperature T_{g} of the binder. Preferably, softeners which do not contain phthalates are used. In alternative embodiments also phthalate-containing softeners can be used. In these alternative embodiments preferably alkyl benzyl phthalates are used as softeners. It is particularly preferable, when the alkyl group of the alkyl benzyl phthalates is a heptane, octane or nonane group. Especially preferably, the alkyl benzyl phthalate is Santicizer S261A. In an alternative also W5000 can be used as a softener. Preferably, the softener has a chemical purity of at least 90% by weight, more preferably at least 95% by weight, still more preferably at least 99% by weight, particularly preferably at least 99.9% by weight.

The provision of a slip of starting materials according to step a) of the method according to the present invention preferably comprises the following steps: dispersing of the ceramic powder in the solvent to a powder dispersion, homogenizing of the powder dispersion to a homogenate, and degassing of the homogenate to a slip.

The step of dispersing of the ceramic powder to a dispersion preferably comprises the following steps: providing of a mixture of solvent and dispersing agent, addition of grinding balls, sintering aids and ceramic powder to the mixture, and dispersing in a mixer.

The mixer according to step a1c) is preferably selected from the group comprising tumbling mixers, overhead mixers, roller bench, ball mills, attritors, high-speed stirrers, vibratory mills and dispersing ultrasonic facilities. It is particularly preferable, when the mixer according to step a1c) is a tumbling mixer.

The time period of the dispersing step according to step a1c) inter alia depends on the agglomeration degree of the ceramic powder and on the mixer used. The dispersing step according to step a1c) is preferably conducted for a time period of at least 6 hours, more preferably at least 12 hours, still more preferably at least 18 hours. When the time period is too short, then the dispersing step is insufficient and the deagglomeration of the ceramic powders is too insufficient. The time period of the dispersing step according to step a1c) is preferably at most 72 hours, more preferably at most 48 hours, still more preferably at most 30 hours. When the time period is too long, then the stability of individual components is compromised. Furthermore, this may also result in disadvantageous grinding ball abrasion. In addition, the homogeneity and the stability of the slip to be obtained can be compromised, when the time period is too long. Finally, the selected time period should also not be too long due to economic reasons. It is particularly preferable, when the dispersing step according to step a1c) is conducted for a time period of 22 to 26 hours.

The homogenization of the powder dispersion according to step a2) preferably comprises the following steps: addition of binder and softener to the powder dispersion, and homogenization in a mixer.

The mixer according to step a1b) is preferably selected from the group comprising tumbling mixers, overhead mixers, roller bench, ball mills, attritors, high-speed stirrers, vibratory mills and dispersing ultrasonic facilities. It is particularly preferable, when the mixer according to step a2b) is selected from the group comprising tumbling mixers, overhead mixers and roller bench. It is particularly preferable, when the mixer according to step a2b) is a tumbling mixer.

The homogenization according to step a2b) is preferably conducted for a time period of at least 6 hours, more preferably at least 12 hours, still more preferably at least 18 hours. When the time period is too short, then the homogenizing step is insufficient. The time period of the homogenizing step according to step a2b) is preferably at most 72 hours, more preferably at most 48 hours, still more preferably at most 30 hours. When the time period is too long, then the stability of individual components is compromised. Furthermore, this may also result in disadvantageous grinding ball abrasion. In addition, the homogeneity and the stability of the slip to be obtained can be compromised, when the time period is too long. Finally, the selected time period should also not be too long due to economic reasons. It is particularly preferable, when the homogenization according to step a2b) is conducted for a time period of 22 to 26 hours.

Preferably, before the step of degassing of the homogenate the grinding balls which are added according to step a1b) are removed. The removal of the grinding balls is preferably conducted by means of a filter.

Preferably, the step of degassing of the homogenate to a slip according to step a3) is conducted in a rotary evaporator.

Preferably, the step of degassing of the homogenate to a slip according to step a3) is conducted at a pressure of at most 800 hPa, more preferably at most 500 hPa, still more preferably at most 300 hPa. When the pressure is too high, then the step of degassing is not sufficient. Preferably, the step of degassing of the homogenate to a slip according to step a3) is conducted at a pressure of at least 50 hPa, more preferably at least 100 hPa, still more preferably at least 200 hPa. When the pressure is too low, then the step of degassing of the homogenate is not sufficient and it is possible that bubbles remain in the slip. A disadvantage of a pressure which is too high is that it is possible that too much solvent is removed from the slip. Thereby the slip composition can be changed. Possible consequences are an increase of the viscosity of the slip or a worse reproducibility of the casting results. It is particularly preferable, when the step of degassing is conducted at a pressure of 210 to 250 hPa.

Preferably, the step of degassing of the homogenate to a slip according to step a3) is conducted for a time period of at least 2 min, more preferably at least 5 min, still more preferably at least 10 min. When the time period is too short, then the step of degassing is not sufficient and too much gas and bubbles remain in the slip. Preferably, the step of degassing of the homogenate to a slip according to step a3) is conducted for a time period of at most 60 min, more preferably at most 45 min, still more preferably at most 30 min. When the time period is too long, then this results in a stability of the homogenate which is not enough. A further disadvantage of a time period which is too long is an excessive removal of solvent from the slip. Thereby the slip composition can be changed. Possible consequences are an increase of the slip viscosity or a worse reproducibility of the casting results. It is particularly preferable, when the step of degassing is conducted for a time period of 15 to 25 min.

A slip provided according to step a) of the method according to the present invention preferably comprises the following composition:

| Component | Fraction (% by volume) |
|---|---|
| Ceramic powder | 5-30 |
| Sintering aid | 0.1-5 |
| Solvent | 50-80 |
| Dispersing agent | 0.3-8 |
| Binder | 1-25 |
| Softener | 0.5-20 |

It is particularly preferable, when the slip in fact consists of the mentioned composition.

A slip provided according to step a) of the method according to the present invention comprises more preferably the following composition:

| Component | Fraction (% by volume) |
|---|---|
| Ceramic powder | 10-20 |
| Sintering aid | 0.5-2 |
| Solvent | 60-70 |
| Dispersing agent | 0.5-3 |
| Binder | 5-15 |
| Softener | 5-10 |

It is still more preferable, when the slip in fact consists of the mentioned composition.

The production of green foils from the slip according to step b) of the method according to the present invention is preferably conducted by foil casting. Preferably, the production of green foils from the slip comprises the following steps: depositing of the slip as a slip layer on a carrier, and drying of the slip layer to the green foil.

Preferably, the carrier is a moving carrier foil. It is particularly preferable, when the moving carrier foil is a silicone-coated PET foil.

Preferably, the foil casting apparatus comprises a casting shoe into which the slip is filled. It is particularly preferable, when the casting shoe is a double chamber casting shoe with two casting knives.

Preferably, the casting knives are adjustable in height. It is particularly preferable, when the casting knives are adjustable in height via micrometer calipers.

Preferably, with the casting knives being adjustable in height a casting gap with variable gap width between the lower edge of the knives and the carrier foil can be adjusted.

Preferably, the thickness of the slip layer being deposited on the carrier foil is controlled by the adjustment of the gap width of the casting gap. Preferably, the casting gap has a gap width of at least 500 μm, more preferably at least 1000 μm, still more preferably at least 2000 μm, particularly preferably at least 2500 μm. When the gap width is too small, then slip layers which are too thin are obtained. Preferably, the casting gap has a gap width of at most 10000 μm, more preferably at most 8000 μm, still more preferably at most 6000 μm, particularly preferably at most 4000 μm. When the gap width is too large, then slip layers which are too thick are obtained. It is especially preferable, when the casting gap has a gap width of 3100 μm to 3300 μm.

It is particularly preferable, when the thickness of the deposited slip layer, in addition or in an alternative to the control via the gap width of the casting gap, is controlled by the drawing speed of the carrier foil. Preferably, the drawing speed of the carrier foil is at least 100 mm/min, more preferably at least 200 mm/min, still more preferably at least 400 mm/min, particularly preferably at least 600 mm/min. When the drawing speed is too low, then slip layers which are too thick are obtained. Preferably, the drawing speed of the carrier foil is at most 5000 mm/min, more preferably at most 3000 mm/min, still more preferably at most 2000 mm/min, particularly preferably at most 1500 mm/min. It is especially preferable, when the drawing speed of the carrier foil is 800 to 1200 mm/min.

Preferably, the thickness of the slip layer is at least 100 μm, more preferably at least 200 μm, still more preferably at least 300 μm. When the slip layer is too thin, then green foils which are too thin are obtained. Preferably, the slip layer has a thickness of at most 4000 μm, more preferably at most 3000 μm, still more preferably at most 2000 μm. When the thickness of the slip layer is too high, then green foils which are too thick are obtained.

Preferably, the thickness of the dried green foil is controlled via the thickness of the slip layer. Preferably, the green foils have thicknesses in a range of 0.5 μm to 8000 μm. Preferably, the thickness of the green foil is at least 5 μm, more preferably at least 50 μm, more preferably at least 100 μm, still more preferably at least 200 μm, particularly preferably at least 300 μm. When the green foil is too thin, then the stability of the green foil is not high enough. Preferably, the green foil has a thickness of at most 3000 μm, more preferably at most 2000 μm, more preferably at most 1500 μm, still more preferably at most 1000 μm, particularly preferably at most 850 μm. When the green foil is too thick, then the optical properties are impaired.

Preferably, the drying of the slip layer to the green foil according to step b2) is conducted in a drying channel. It is particularly preferable, when the drying of the slip layer to the green foil is conducted by extraction of air.

Preferably, the green foil comprises pores in a fraction of at least 1% by volume, more preferably at least 2% by volume, still more preferably at least 4% by volume. When the fraction of the pores is too low, then the bonding of the green foils to a layer composite according to step c) of the method according to the present invention is hampered. Preferably, the green foil comprises pores in a fraction of at most 75% by volume, more preferably at most 50% by volume, still more preferably at most 25% by volume. When the fraction of the pores is too high, then the mechanical stability of the green foils is not sufficient.

Preferably, the fraction of the pores in the green foil can be adjusted in a targeted manner. Particularly preferably, the fraction of the pores is adjusted by the ratio of binder and softener on the one hand to the ceramic powder on the other hand. When the fraction of binder and softener is so low that after drying not all voids between the ceramic particles can be filled, then pores remain in the green foil.

Preferably, the ratio of the sum of the volume fractions of binder and softener to the volume fraction of the ceramic powder, each based on the slip, is at least 0.2, more preferably at least 0.5, still more preferably at least 1. When the ratio is too low, then green foils with a fraction of pores which is too high are obtained. Preferably, the ratio of the sum of the volume fractions of binder and softener to the volume fraction of the ceramic powder, each based on the slip, is at most 10, more preferably at most 5, still more preferably at most 2. When the ratio is too high, then green foils with a fraction of pores which is too low are obtained.

Green foils prepared according to step b) of the method according to the present invention preferably comprise the following composition:

| Component | Fraction (% by volume) |
|---|---|
| Ceramic powder | 20-60 |
| Sintering aid | 0.5-10 |
| Dispersing agent | 1-15 |
| Binder | 5-45 |
| Softener | 2-40 |
| Pores | 2-40 |

Particularly preferably, the green foils consist exactly of the mentioned composition.

More preferably, green foils prepared according to step b) of the method according to the present invention comprise the following composition:

| Component | Fraction (% by volume) |
|---|---|
| Ceramic powder | 30-45 |
| Sintering aid | 1-5 |
| Dispersing agent | 2-10 |
| Binder | 15-30 |
| Softener | 10-25 |
| Pores | 5-25 |

Still more preferably, the green foils consist exactly of the mentioned composition.

According to step c) of the method according to the present invention preferably a layer arrangement of the green foils comprising at least one porous and at least one further layer is provided. The provision of the layer arrangement preferably comprises the following steps: providing of the at least one porous layer, providing of the at least one further layer, and arranging of the layers to a layer arrangement.

The provision of at least one porous layer according to step c1) is preferably conducted by providing at least one green foil obtained according to step b).

Preferably, the provision of the at least one further layer according to step c2) comprises sintering in vacuum of at least one green foil obtained according to step b).

In a preferable embodiment in step c2) exactly one further layer is provided by sintering in vacuum of exactly one green foil obtained according to step b).

In an alternative embodiment in step c2) at least two further layers are provided. In this embodiment the provision of the at least two further layers is preferably conducted by sintering in vacuum of a layer composite of at least two green foils obtained according to step b).

The bonding of at least two green foils to a layer composite preferably comprises the following steps: providing of a stack comprising at least two green foils, and bonding of the green foils to a layer composite.

Before the step of providing the stack according to step c2a) the green foils are preferably cut into the desired geometry. The cutting of the green foils is preferably conducted by a method selected from punch cutting, scissors cutting, scalpel cutting, hot cutting and laser cutting. Hot cutting is particularly preferable.

Preferably, the bonding of the green foils to a layer composite according to step c2b) is conducted by lamination. Particularly preferably, the bonding is conducted by applying a mechanical pressure onto the stack provided according to step c2a) at a temperature of 20° C. to 120° C., more preferably 50° C. to 80° C. (thermal compression). In this method a mechanical pressure of preferably between 5 MPa and 300 MPa, more preferably between 20 MPa and 150 MPa is used. The pressure input may be an uniaxial or isostatic one.

According to the present invention also other lamination methods such as cold low pressure lamination can be used.

Surprisingly it was found that with a coating weight of preferably 20 to 100 Pa, more preferably 30 to 70 Pa of Kelapor this material does not react with the foil to be sintered and thus an easily sintered planar ceramic foil can be obtained. For achieving the desired coating weight, Kelapor is preferably used in a thickness of 0.5 mm to 5 mm.

In a preferable embodiment the mechanical pressure is a uniaxial one. In an alternative embodiment the pressure is an isostatic one.

Particularly preferably, the bonding of the green foils to a layer composite is achieved by viscos flowing of green foil bulk mass into the open pores of the adjacent green foil. It is especially preferable, when the single layers of the layer composite are bonded together in such a manner that they do not separate from each other during the sintering step.

Preferably, before the step of sintering in vacuum the binder is burned out from the at least one green foil. The step of burning out the binder is preferably conducted at maximum temperatures of lower than 800° C., more preferably lower than 700° C., still more preferably lower than 650° C., particularly preferably at maximum temperatures of at most 600° C. When the maximum temperature of the step of burning out is too high, then already the first stage of sintering starts and the structure of the green foils may be compromised. The step of burning out the binder is preferably conducted at maximum temperatures of at least 300° C., more preferably at least 350° C., still more preferably at least 400° C., particularly preferably at least 450° C. When the maximum temperature of the step of burning out is to low, then the step of burning out the binder is not comprehensive enough. It is particularly preferable, when the step of burning out the binder is conducted at maximum temperatures of 500° C. to 600° C. Preferably, the step of burning out the binder is conducted with heating rates of about 2 K/min.

For burning out the binder the green foils are preferably maintained at the maximum burning out temperature for a time period of 0.5 hours to 3 hours.

Higher burning out times and temperatures involve longer plant times. Therefore, burning out times and temperatures which are as low as possible are preferable. But the burning out times and temperatures have to be sufficiently high so that the binder is removed from the green foils in a manner which is as comprehensive as possible, without compromising the structure of the green foils.

Preferably, the step of sintering in vacuum is conducted at temperatures of at least 1500° C., more preferably at least 1550° C., particularly preferably at least 1600° C. When the temperature is too low, then the sintering process does not take place in a manner which is sufficient. Preferably, the step of sintering is conducted at temperatures of at most 1900° C., more preferably at most 1800° C., still more preferably at most 1750° C., especially preferably at most 1700° C. The stability of the materials is too low for temperatures which are too high.

The volume fraction of the pores in the green foils is preferably reduced by the step of sintering in vacuum. Particularly preferably, the further layer comprises pores in a volume fraction of at most 1%, more preferably at most 0.5%, still more preferably at most 0.1%, particularly preferably at most 0.05%.

The further layer preferably has an inline transmission of at least 50% at a wave length of 600 nm.

In an alternative also other sintering methods can be used. Preferable alternative sintering methods are hot isostatic pressing (HIP) and spark plasma sintering (SPS).

In alternative embodiments in step c2) the at least one further layer is provided by sintering of at least one green foil obtained according to step b) under O₂ flux with slight N₂ overpressure or in air. Depending on the composition a suitable sintering regime can be selected. In the case of yttrium aluminum garnet (YAG) in the alternative embodiments it is preferably sintered under O₂ flux. In the case of oxynitrides in the alternative embodiments it is preferably sintered with slight N₂ overpressure. In the case of spinels in the alternative embodiments it is preferably sintered in air.

For reducing the fraction of pores also in the case of sintering without vacuum, the step of sintering in the alternative embodiments is preferably conducted at higher temperatures than the sintering in vacuum. Particularly preferably, the sintering temperatures in the alternative embodiments are at least 30° C., more preferably at least 50° C., still more preferably at least 60° C. higher than the sintering temperatures in the case of sintering in vacuum. Preferably, the step of sintering in the alternative embodiments is conducted at temperatures of at least 1600° C., more preferably at least 1650° C., particularly preferably at least 1700° C.

With the combination of at least one porous layer and at least one further layer the color location of the light emitted from the layer composite according to the present invention can be adjusted in a targeted manner.

In a particularly preferable embodiment the layer arrangement provided according to step c) of the method according to the present invention consists of two porous layers between which exactly one further layer obtained according to step c2) is disposed.

Preferably, the bonding of the layers of the layer arrangement provided according to step c) is conducted in step d) of the method according to the present invention by lamination. It is particularly preferable, when the bonding of the layers is conducted by cold low pressure lamination. The cold low pressure lamination is preferably conducted at temperatures of 10° C. to 30° C., more preferably 15° C. to 25° C. The pressures in the case of cold low pressure lamination are preferably lower than 5 MPa.

Preferably, the step of sintering conducted according to step e) of the layer composite provided according to step d) is a step of “constrained sintering” in air. “Constrained sintering” means hampering of the shrinkage during sintering and/or compaction under hampering of the shrinkage. Preferably, the sintering conducted according to step e) is conducted in a chamber kiln under O₂ flux.

Preferably, by the step of sintering the at least one porous layer of the layer composite becomes a porous optoceramic layer.

Preferably, by the step of sintering the at least one porous layer of the layer composite shrinks only in z direction (thickness).

Preferably, by sintering in air a residual porosity remains in the at least one porous layer.

The porous layer preferably comprises pores in a volume fraction of at least 2.5%, more preferably at least 3%, still more preferably at least 3.5%. When the fraction of the pores is too low, then the scattering effects are not high enough. The porous layer preferably comprises pores in a volume fraction of at most 20%, more preferably at most 10%, especially preferably at most 5%. When the fraction of the pores is too high, then mechanically instable layers are obtained.

Preferably, the burning out of the binder from the at least one porous layer is conducted at temperatures of up to 600° C., more preferably up to 650° C., still more preferably up to 700° C. as a part of the regular sintering profile.

In a particularly preferable embodiment the layer composite consists of exactly two porous optoceramic layers as well as one further optoceramic layer which is disposed between both porous optoceramic layers. Such a layer composite can be prepared according to the present invention in a particularly good manner. For the production of such a layer composite at first preferably the further optoceramic layer is sintered. Onto this rigid further optoceramic layer on the upper side and the lower side flexible green foils are laminated. Subsequently, they are sintered to porous optoceramic layers. Preferably, the sintering is conducted in two steps for guaranteeing the differences in porosity and/or thickness. With the application of two flexible layers onto a rigid optoceramic layer a lamination which is free from defects as far as possible can be guaranteed best. It has been shown that it is advantageous at first to produce the dense layer and subsequently to produce the porous layers from the laminated green foils.

In alternative embodiments the layer composite according to the present invention may also consist of exactly two further optoceramic layers as well as one porous optoceramic layer which is disposed between both further optoceramic layers. But the production of such a layer composite is much more difficult. For the production of such a layer composite preferably in the first step of sintering a porous optoceramic layer is produced. Subsequently, preferably onto the upper side and onto the lower side of the porous optoceramic layer green foils are laminated. Preferably, then the green foils are sintered to high density. But the technical challenges involved in such a lamination process are high, since the porous optoceramic layer normally has a lower mechanical strength. This may result in fracture of the porous optoceramic layer during the step of lamination, thus before the second step of sintering.

In further alternative embodiments of the present invention all foils in the green non-sintered state can be laminated onto each other and can then be compacted in a common step of sintering. A symmetric structure may facilitate a warp-free sintering of the product.

According to the present invention is also the use of the layer composite of the present invention as a converter. Preferably, the layer composites are used in computer tomography scanners, scintillators or as converter materials for diodes, particularly preferably for LEDs or LDs. It is particularly preferable, when the layer composites are used according to the present invention as converter materials for LEDs or LDs. Especially preferable is the use of the layer composites as converter materials for LEDs.

### BRIEF DESCRIPTION OF THE DRAWINGS

FIG. 1 shows a layer composite according to the present invention in a schematic manner.

FIG. 2 shows another embodiment of the layer composite according to the present invention in a schematic manner.

FIG. 3 shows another embodiment of the layer composite according to the present invention in a schematic manner.

FIG. 4 shows an exemplary simulation of the absorption of blue light as a function of the way which the light has covered through the layer composite of the present invention.

FIG. 5 shows the emission spectra of two different embodiments of the present invention.

FIG. 6 shows transmission with LED excited along the color grades via a sintering variation and/or via a thickness variation.

FIG. 7 shows that quantum efficiency (QE) is not influenced by the multilayer structure.

### DETAILED DESCRIPTION

### Example 1

### Ce:Yag

Ceramic powders with primary particles with diameters of smaller than 1 μm of 2.5 mol Al₂O₃, 1.4965 mol Y₂O₃ and 0.0863 mol CeO₂ were weighed in in ratio according to the target composition and were added together with TEOS and grinding balls to a mixture of ethanol, toluene and TODS. The ceramic powders were characterized by a specific surface of 12 to 30 m²/g and a chemical purity of higher than 99.99% by weight. Ethanol, toluene, TEOS and TODS were characterized by a chemical purity of higher than 99% by weight. Over a time period of 24 hours in a tumbling mixer a powder dispersion was produced. Subsequently, PVB and Santicizer S261A were added and over a time period of 24 hours in a tumbling mixer a homogenate was produced. Subsequently, the grinding balls were removed by means of a filter and the homogenate was degassed in a rotary evaporator for 20 min at 230 mbar to a slip.

The slip was characterized by the following composition:

| Component | Fraction (% by volume) |
|---|---|
| Al₂O₃ + Y₂O₃ + CeO₂ + TEOS | 15.07 |
| Ethanol + toluene | 66.62 |
| TODS | 1.69 |
| PVB | 9.07 |
| Santicizer S261A | 7.56 |

The casting of the foil was conducted with a foil casting apparatus with moving silicone-coated carrier foil of PET. At first, the slip was filled into a double chamber casting shoe with two casting knives. The casting knives were adjustable in height via micrometer calipers. With the casting knives being adjustable in height a casting gap between the lower edge of the knives and the carrier foil was adjusted.

The slip layer was deposited on the carrier foil and was transferred with the carrier foil into a drying channel. In the drying channel the slip layer was dried under extraction of air to the green foil. The thickness of the green foil was ca. 200 μm.

The green foil was characterized by the following composition:

| Component | Fraction (% by volume) |
|---|---|
| Al₂O₃ + Y₂O₃ + CeO₂ + TEOS | 36.76 |
| TODS | 4.12 |
| PVB | 22.12 |
| Santicizer S261A | 18.44 |
| Pores | 18.57 |

The green foil was cut into squares of a size of 5×5 mm² by hot cutting.

Some of the green foil pieces were at first subjected to a step of burning out of the binder at a temperature of 550° C. in air. Subsequently, these green foil pieces were sintered in vacuum at 1630° C. to 1680° C. for 3 hours. By the step of sintering in vacuum the volume fraction of the pores was reduced to 0.1%. Here green foil pieces with an inline transmission of higher than 50% at a wave length of 600 nm were obtained. The thickness in the sintered state was 100 μm.

Onto the upper side and the lower side of a vacuum-sintered foil piece each a non-sintered porous green foil piece was laminated by means of cold low pressure lamination. The laminate was sintered in air by means of “constrained sintering” in a chamber kiln. So a strong composite of the three foil pieces was prepared. During sintering both porous green foil pieces which have been laminated onto the vacuum-sintered foil piece shrunk only in z direction (thickness). By the step of sintering in air both porous foil pieces maintained a residual porosity. After the step of sintering in air both porous foil pieces were characterized by a volume fraction of pores of ca. 5%. A translucent layer composite comprising a middle layer with low scattering and two outer layers with higher scattering was obtained. So it was possible to adjust the color location of the light emitted from the layer composite in a targeted manner.

### Example 2

### Ce:Ygag

A translucent layer composite consisting of three layers as described in example 1 was prepared with the modification that the step of sintering in vacuum was conducted at temperatures of between 1600° C. and 1650° C. and that no TEOS was used. As ceramic powders Al₂O₃, Y₂O₃, Gd₂O₃ and CeO₂ powders were used. The ceramic powders each were characterized by a specific surface of 12 to 30 m²/g and a chemical purity of higher than 99.99% by weight. The fraction of the CeO₂ powder was 0.1% by weight, based on the total weight of the ceramic powders.

### Example 3

### Ce:Luag

A translucent layer composite consisting of three layers as described in example 1 was prepared with the modification that the step of sintering in vacuum was conducted at temperatures of between 1600° C. and 1680° C. for a time period of 6 hours and that no TEOS was used. As ceramic powders Al₂O₃, Lu₂O₃ and CeO₂ powders were used. The ceramic powders each were characterized by a specific surface of 12 to 30 m²/g and a chemical purity of higher than 99.99% by weight. The fraction of the CeO₂ powder was 0.2% by weight, based on the total weight of the ceramic powders.

### Example 4

### Ce:LuAGG

A translucent layer composite consisting of three layers as described in example 1 was prepared with the modification that the step of sintering in vacuum was conducted at temperatures of between 1600° C. and 1680° C. for a time period of 6 hours. As ceramic powders Al₂O₃, Ga₂O₃, Lu₂O₃ and CeO₂ powders were used. The ceramic powders each were characterized by a specific surface of 12 to 30 m²/g and a chemical purity of higher than 99.99% by weight. The fraction of the CeO₂ powder was 0.2% by weight, based on the total weight of the ceramic powders.

### Example 5

### Ce:YAG+Dextrose

A translucent layer composite consisting of three layers as described in example 1 was prepared with the modification that dextrose was added to the ceramic powders before the step of dispersing in a volume fraction of 10%, based on the ceramic powder.

### Example 6

With the same composition the color location in transmission with LED excited along the color grades via a sintering variation and/or via a thickness variation can be adjusted.

The results are summarized in TABLE 1.

TABLE 1

| | | | |
|---|---|---|---|
| 157/EC- | Foil 38; 5 layers | Vacuum 10-5 | 1625 |
| 376 | | | |
| 158/EC- | Foil 38; 5 layers | Vacuum 10-5 | 1650 |
| 377 | | | |
| 159/EC- | Foil 38; 5 layers | Vacuum 10-5 | 1700 |
| 378 | | | |
| 160/EC- | Foil 38; 5 layers | Vacuum 10-5 | 1750 |
| 379 | | | |
| 161/EC- | Foil 29.2; 5 layers | Vacuum 10-5 | 1725 |
| 380 | | | |
| 162/EC- | Foil 38/39/38; (1/5/1) | Core: vacuum 10-5 | K: 1650 |
| 381 | layers | gradient: air | G: 1700 |
| 163/EC- | Foil 38/39/38; (1/5/1) | Core: vacuum 10-5 | K: 1650 |
| 382 | layers | gradient: air | G: 1700 |
| 164/EC- | Foil 38/39/38; (1/5/1) | Core: vacuum 10-5 | K: 1750 |
| 383 | layers | gradient: air | G: 1700 |
| 165/EC- | Foil 40; 5 layers | Vacuum 10-5 | 1650 |
| 384 | | | |
| 166/EC- | Foil 40; 5 layers | Vacuum 10-5 | 1700 |
| 385 | | | |
| 167/EC- | Foil 40; 5 layers | Vacuum 10-5 | 1750 |
| 386 | | | |
| 168/EC- | Foil 39/38/39; (1/5/1) | Vacuum 10-5 | 1600 |
| 387 | layers | | |
| 169/EC- | Foil 39/38/39; (1/5/1) | Vacuum 10-5 | 1650 |
| 388 | layers | | |
| 170/EC- | Foil 39/38/39; (1/5/1) | Vacuum 10-5 | 1700 |
| 389 | layers | | |
| 171/EC- | Foil 39/38/39; (1/5/1) | Vacuum 10-5 | 1700 |
| 390 | layers | | |
| 172/EC- | Foil 39/38/39; (1/5/1) | Vacuum 10-5 | 1700 |
| 391 | layers | | |
| 173/EC- | Foil 39/38/39; (1/5/1) | Vacuum 10-5 | 1750 |
| 392 | layers | | |

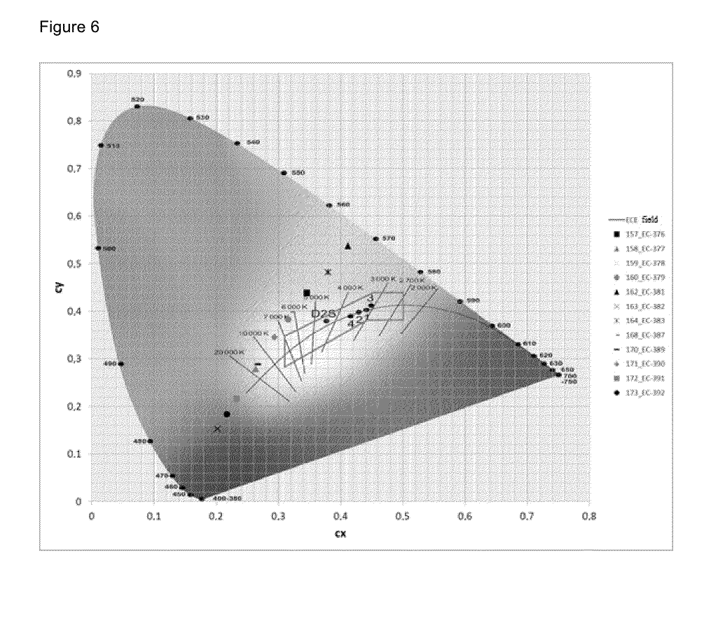

In addition, the results are presented in FIG. 6.

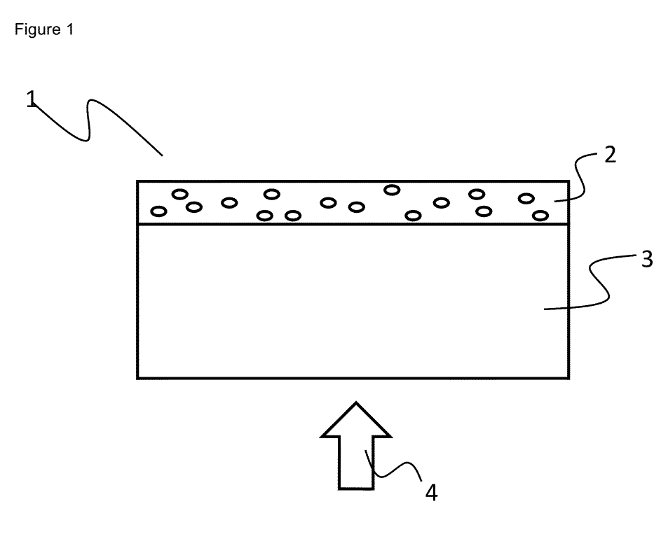

FIG. 1 shows a preferable embodiment of the layer composite according to the present invention (1) in a schematic manner. In this embodiment the layer composite (1) consists of one porous optoceramic layer (2) and one further optoceramic layer (3). In this embodiment the further optoceramic layer (3) is preferably a doped optoceramic layer and the porous optoceramic layer (2) is preferably an undoped optoceramic layer. Arrow (4) shows the direction of the way of the light to be converted through the layer composite according to the present invention in a schematic manner.

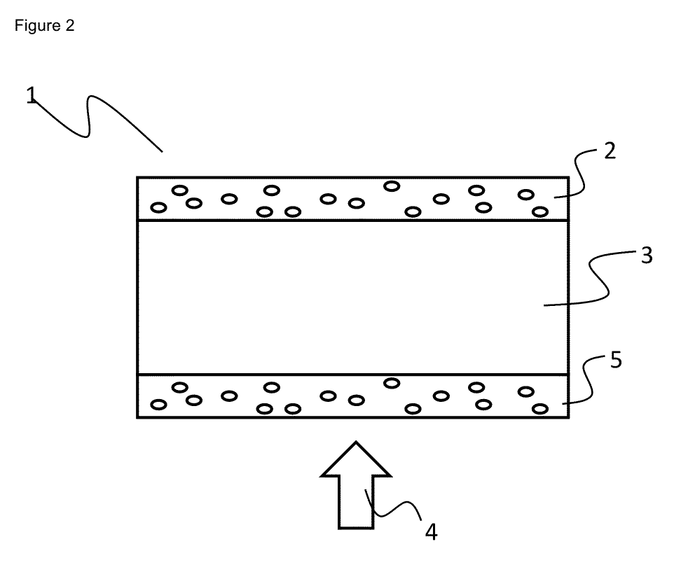

FIG. 2 shows a more preferable embodiment of the layer composite according to the present invention (1) in a schematic manner. In this embodiment the layer composite (1) consists of two porous optoceramic layers (2, 5) and one further optoceramic layer (3) which is disposed between both porous optoceramic layers (2, 5). In this embodiment the further optoceramic layer (3) is preferably a doped optoceramic layer and both porous optoceramic layers (2, 5) are preferably undoped optoceramic layers. Arrow (4) shows the direction of the way of the light to be converted through the layer composite according to the present invention in a schematic manner.

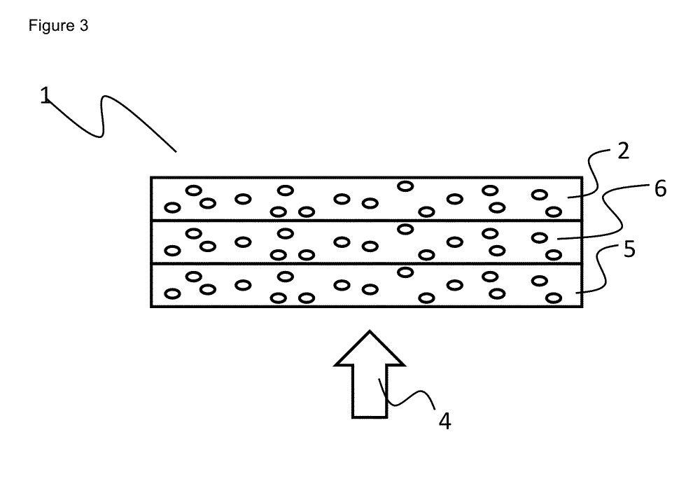

FIG. 3 shows a particularly preferable embodiment of the layer composite according to the present invention (1) in a schematic manner. In this embodiment the layer composite (1) consists of three porous optoceramic layers (2, 6, 5). In this embodiment each of the three porous optoceramic layers (2, 6, 5) is a doped optoceramic layer, wherein their optoceramic phases are characterized by different contents by weight of optically active center. Arrow (4) shows the direction of the way of the light to be converted through the layer composite according to the present invention in a schematic manner. In this embodiment the layer composite is arranged such that the light to be converted successively passes doped optoceramic layers with increasing content of optically active center. Thus, the content of optically active center in optoceramic layer (5) is the lowest and the content of optically active center in optoceramic layer (2) is the highest. The content of active center in optoceramic layer (6) is higher than the content of optically active center in optoceramic layer (5), but lower than the content of optically active center in optoceramic layer (2). Preferably, the fraction of optically active center in optoceramic layer (2) is at least two times higher than the content of optically active center in optoceramic layer (5).

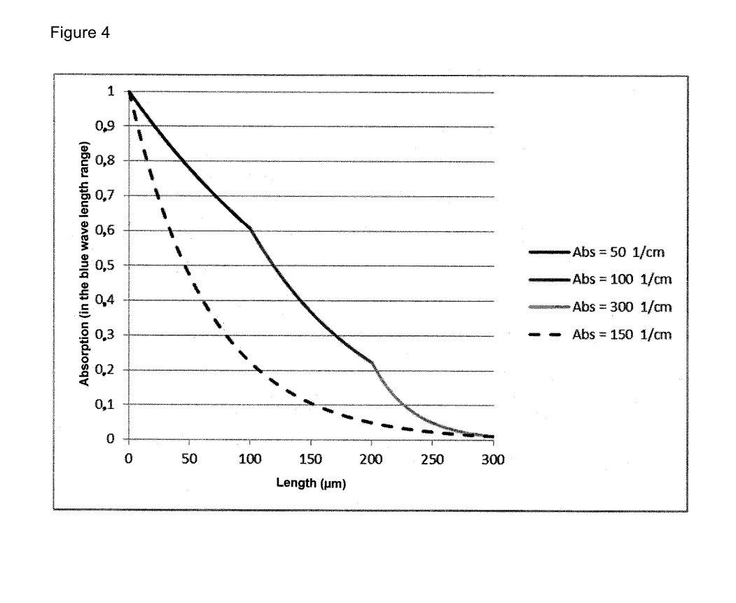

FIG. 4 shows an exemplary simulation of the absorption of blue light as a function of the way which the light has covered through the layer composite. The absorptions in two different layer composites are shown in comparison. Both layer composites consist of three optoceramic layers with a thickness of 100 μm each. The structure of the first layer composite corresponds to the layer composite shown in FIG. 3. Here, the content of optically active center in optoceramic layer (6) is two times higher than in optoceramic layer (5). The content of optically active center in optoceramic layer (2) is even six times higher than in optoceramic layer (5). So a uniform absorption of blue light over the thickness of the layer composite is achieved. The absorption of blue light as a function of the way which the light has covered through the layer composite in reference to the first layer composite is depicted in FIG. 4 with solid lines. The second layer composite consists of three optoceramic layers with identical content of optically active center each. In the present simulation for the content the triple in comparison to the content in optoceramic layer (5) of the first layer composite was selected. The absorption of blue light in the second layer composite is depicted with a dashed line and it can be seen that it is extremely nonuniform. The majority of the light is already absorbed in the optoceramic layer which corresponds to the optoceramic layer (5) of FIG. 3.

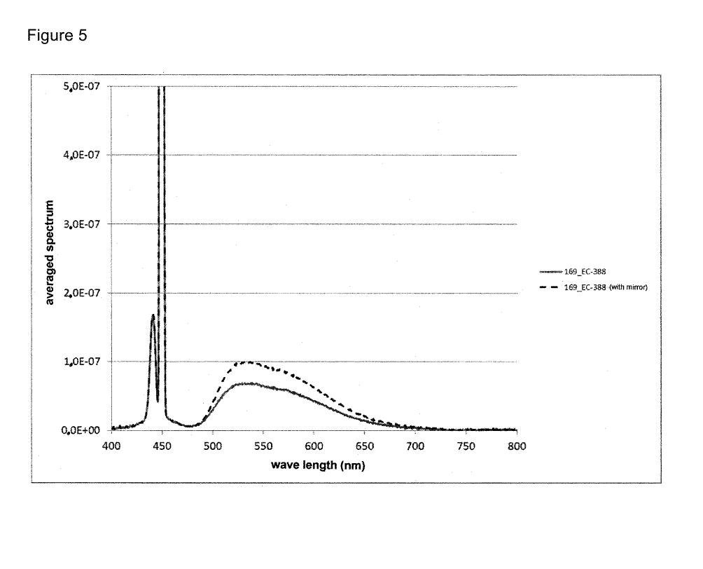

FIG. 5 shows the emission spectra of two different embodiments of the present invention. Both layer composites comprise two translucent optoceramic layers between which a doped optoceramic layer is disposed. However one of the layer composites comprises a reflecting layer in addition. By the reflecting layer the emission of yellow light is increased.

FIG. 6 shows that with the same composition the color location in transmission with LED excited along the color grades via a sintering variation and/or via a thickness variation can be adjusted.

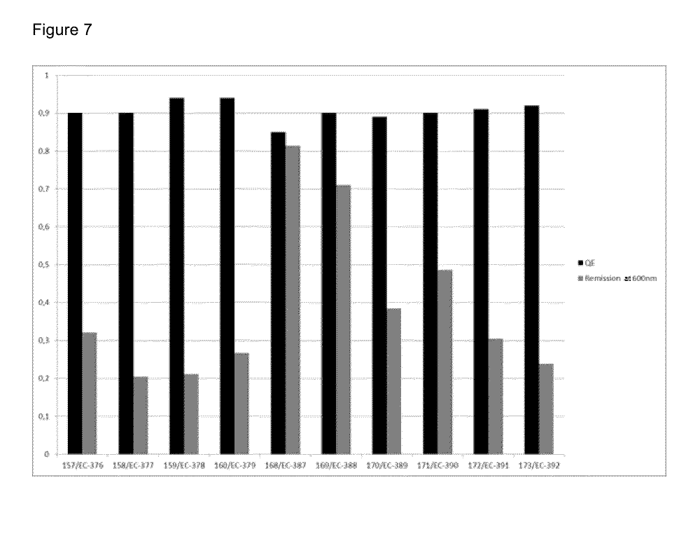

FIG. 7 shows that the quantum efficiency (QE) is not influenced by the multilayer structure, but the remission however. But the remission property can be influenced. For a white impression of the converter a scattering layer at EC-388 can be added.

### LIST OF REFERENCE SIGNS

1 Layer composite
2 Porous optoceramic layer
3 Further optoceramic layer
4 Direction of the light to be converted
5 Porous optoceramic layer
6 Porous optoceramic layer

What is claimed is:

1. A layer composite comprising at least one porous optoceramic layer and at least one further optoceramic layer, wherein the at least one porous optoceramic layer comprises pores in a volume fraction of at least 2.5%.

2. The layer composite according to claim 1, wherein the pores of the at least one porous optoceramic layer have a maximum inner diameter of at least 0.1 μm.

3. The layer composite according to claim 1, wherein the at least one further optoceramic layer comprises pores in a volume fraction of at most 1.5%.

4. The layer composite according to claim 3, wherein the pores of the at least one further optoceramic layer have a maximum inner diameter of at least 0.1 μm.

5. The layer composite according to claim 1, wherein the at least one porous optoceramic layer and the at least one further optoceramic layer are translucent.

6. The layer composite according to claim 1, wherein the at least one porous optoceramic layer and the at least one further optoceramic layer comprise an optoceramic phase which comprises crystallites, wherein the crystallites have the chemical empirical formula AₓB_{y}O_{z} with x≧1, y≧0 and x+y=⅔z and wherein A is a member of the scandium group or a lanthanide and B is a member of the boron group.

7. The layer composite according to claim 1, further comprising at least one doped optoceramic layer.

8. The layer composite according to claim 1, further comprising at least one undoped optoceramic layer.

9. The layer composite according to claim 1, wherein the layer composite is configured for use as a converter material for LED's.

10. A method for the production of a layer composite, comprising the steps of:
a) providing a slip of starting materials,
b) preparing green foils from the slip,
c) providing a layer arrangement of the green foils comprising at least one porous layer and at least one further layer,
d) bonding the at least one porous and at least one further layers of the layer arrangement to for the layer composite, and
e) sintering the layer composite.

11. The method according to claim 10, wherein the slip has the following composition in % by volume:

| | |
|---|---|
| seramic powder | 5-30; |
| sintering aid | 0.1-5; |
| Solvent | 50-80; |
| dispersing agent | 0.3-8; |
| Binder | 1-25; and |
| softener | 0.5-20. |
